(19) United States
(12) Patent Application Publication
(10) Pub. No.: US 2025/0215302 A1
(43) Pub. Date: Jul. 3, 2025

(54) COPPER-BASED COMPOSITE METAL OXIDE HEAT STORAGE MATERIAL AND PREPARATION METHOD THEREOF

(71) Applicant: ZHEJIANG UNIVERSITY, Hangzhou (CN)

(72) Inventors: Gang XIAO, Hangzhou (CN); Jiali Deng, Hangzhou (CN)

(21) Appl. No.: 18/852,230

(22) PCT Filed: Nov. 23, 2022
(86) PCT No.: PCT/CN2022/133765

§ 371 Date: Sep. 27, 2024

(30) Foreign Application Priority Data
Mar. 31, 2022 (CN) 202210345798.8

(51) Int. Cl. C09K 5/14

(52) U.S. Cl. CPC C09K 5/14

(57) ABSTRACT

A copper-based composite metal oxide heat storage material surface-coated with spinel-type structural carriers and a preparation method thereof, in which the spinel-type carrier material is prepared by using a sol-gel method, and then the copper-based composite metal oxide heat storage material is obtained by forming a composite of the spinel-type carriers and copper oxide through a high-temperature solid-state method. The spinel-type structural material has good high-temperature thermal stability and chemical stability, and the spinel-type structural material employed as carriers is coated on surfaces of the copper-based metal oxide to effectively improve the high-temperature sintering of the copper-based heat storage material, thereby improving re-oxidation degree (near 100%) and reaction rate of the copper-based composite metal oxide heat storage material, and has a superior cyclic heat storage/heat release performance.

### TECHNICAL FIELD

The present disclosure relates to the field of heat storage materials technology, and particularly relates to a modified copper-based composite metal oxide heat storage material surface-coated with spinel-type carriers and a preparation method thereof.

### BACKGROUND ART

Energy storage is one of the important support technologies for achieving the “carbon peaking and carbon neutrality” goals, and the development and maturity of the energy storage industry are keys to the sustainable and steady development and large-scale use of renewable energy sources. Heat storage is a kind of large-scale energy storage and is an effective means for realizing efficient utilization of renewable energy sources.

Heat storage mainly includes three forms: sensible heat, latent heat of phase change, and chemical reaction heat. Sensible heat storage (such as molten salt, thermal conductive oil, water/steam) mainly uses the temperature rise and fall of the medium to realize the storage and release of heat, the process is relatively simple and the application is the widest, but its heat storage temperature generally does not exceed 570° C. the energy density of heat storage is small, the temperature fluctuation is large, and it is difficult to meet requirements of the next-generation high-temperature application technologies (>700° C.). Latent heat storage utilizes the latent heat of a medium's phase change process to realize the storage and release of heat, but its thermal conductivity is low, and it difficult to control heat exchange during the phase change process, and phase change materials typically require encapsulation, making the process complicated and costly. Chemical reaction heat storage utilizes the thermal effects of reversible chemical reactions to storage and release energy. Depending on the application scenario and heat storage/heat release requirements, a wide range of reactants can be selected. In addition, the energy storage density can be one order of magnitude higher than that of the sensible heat, making it convenient for long-term storage or long-distance transportation. A high-temperature thermochemical energy storage technology based on metal oxides (such as cobalt/manganese/copper/iron) realizes energy storage/release through reduction/oxidation reactions between metal oxides of different valencies, the heat storage temperature can reach 800° C. or more, and the energy storage density can reach 300 to 1000 kJ/kg within a small temperature change range, and its typical reaction formula is as follows:

MₓO_{y+z}+ΔH==MₓO_{y}+z/2*O₂

Here, the copper oxide system has the advantages of high energy density, non toxic and not dangerous, fast reduction rate, small temperature difference between heat storage/heat release reactions and high energy grade, but the copper oxide system has serious particle agglomeration and sintering problem under the high-temperature reaction condition, namely the copper oxide particles are agglomerated and grown under the high-temperature condition, the surface area is reduced, so that the re-oxidation reaction degree of the material is low, the oxidation reaction rate is slow, the copper oxide particles obviously shrink and are densified after multiple cycles of heat storage/heat release reactions, the cycle life is short, and thus is will limit the large-scale multi-scene application of the copper oxide particles as heat storage materials.

### SUMMARY OF THE INVENTION

To overcome the aforementioned drawbacks of the prior art, the present disclosure provides a copper-based composite metal oxide heat storage material, which can solve the problem of particle agglomeration and sintering of copper oxide particles under a high-temperature reaction condition through spinel-type carriers adhering to surfaces of the copper oxide particles.

In one aspect, the present disclosure provides a copper-based composite metal oxide heat storage material obtained by forming a composite of copper oxide particles and spinel-type carriers, in which the spinel-type carriers adhere to surfaces of the copper oxide particles.

In accordance with this aspect, first, due to a stable crystal form, strong structure, high melting point, and stable chemical properties of spinel-type materials, the spinel-type carriers in the copper-based composite metal oxide heat storage material provided in the present disclosure do not react with the copper oxide particles under a high-temperature reaction condition, which avoids a decrease in the content of the main reactant (copper oxide).

Second, through the applicant's experimental research, it has been found that there is a strong interaction between the spinel-type carriers and the copper oxide particles, so that the spinel-type carriers adhere to the surfaces of the copper oxide particles, and are not easy to fall off during multiple cycles of heat storage/heat release reactions.

Finally, since the spinel-type carriers can adhere to the surfaces of the copper oxide particles, it can effectively block the contact between the copper oxide particles, avoid agglomeration and sintering of the copper oxide particles under the high-temperature reaction condition. Moreover, in multiple cycles of heat storage/heat release reactions, the spinel-type carriers can stably exist on the surfaces of the copper oxide particles, so that the copper-based composite metal oxide heat storage material provided by the present disclosure has excellent cyclic heat storage/heat release performance and can maintain a high heat storage/heat release density after multiple cycles.

In an exemplary aspect of the present disclosure, the mass fraction of the spinel-type carriers is equal to or more than 10% of the mass of the copper-based composite metal oxide heat storage material.

In accordance with this aspect, since the agglomeration and sintering phenomenon of the copper oxide particles can occur under the high-temperature reaction condition, too few spinel-type carriers cannot effectively block the contact between the copper oxide particles, causing a portion of the copper oxide particles still undergoing agglomeration and sintering phenomenon. However, more than 10% spinel-type carriers can effectively block the contact between the most copper oxide particles, in which the higher the mass fraction and more uniform the distribution of the spinel-type carriers, the better the blocking effect of the agglomeration between the copper oxide particles.

In an exemplary aspect of the present disclosure, the mass fraction of the copper oxide is 1-x, the mass fraction of the spinel-type carriers is x, and x is selected from a range of 10% to 20%.

In accordance with this aspect, when the mass fraction of the spinel-type carriers is higher than 10%, it can effectively block the agglomeration between the copper oxide particles and avoid agglomeration and sintering phenomenon of the copper oxide particles under the high-temperature reaction condition. However, the higher the mass fraction of the spinel-type carriers, the lower the mass fraction of the copper oxide particles. The main reactant of the copper-based composite metal oxide heat storage material is the copper oxide particles, and the content of the copper oxide particles is low. Therefore, the energy density of the heat storage/heat release reaction of the material under the same mass conditions is reduced. Moreover, too many spinel-type carriers adhere to the surfaces of the copper oxide particles, easily causing insufficient contact reaction area between the copper oxide particles and air. Therefore, when the mass fraction of the spinel-type carriers is 10% to 20%, it is possible to give consideration to the heat storage/heat release density and cycle performance of the copper-based composite metal oxide heat storage material.

In an exemplary aspect of the present disclosure, the spinel-type carriers are granular. In accordance with this aspect, when the granular spinel-type carriers adhere to the surfaces of the copper oxide particles, the granular spinel-type carriers are in point contact with the surfaces of the copper oxide particles, so that the blocking effect on the copper oxide particles is ensured, and meanwhile, the copper oxide particles have a large reaction contact area with air. Therefore, in multiple cycles of heat storage/heat release reactions, the copper-based composite metal oxide heat storage material provided by the present disclosure has a large reaction area and the re-oxidation degree and reaction rate of the copper-based composite metal oxide heat storage material in the cycles of heat storage/heat release reactions are further improved.

In an exemplary aspect of the present disclosure, the surfaces of the copper oxide particles are uniformly coated with the granular spinel-type carriers.

In accordance with this aspect, the spinel-type carriers having smaller particle size uniformly adhere to the surfaces of the copper oxide particles having larger particle size, so that the spinel-type carrier particles uniformly distributed on the surfaces of the copper oxide particles can block the agglomeration between the copper oxide particles without affecting the reaction area of the copper oxide particles and air, and the blocking effect of the spinel-type carrier with the same mass fraction on the agglomeration phenomenon between the copper oxide particles is improved to the maximum extent.

In an exemplary aspect of the present disclosure, the spinel-type carriers are a combination of one or more of MgCr₂O₄, ZnCr₂O₄, ZnAl₂O₄, and NiAl₂O₄.

In another aspect, the present disclosure provides a method for preparing the copper-based composite metal oxide heat storage material according to the above technical solution, the method comprising:
a step S1 of preparing spinel-type carriers using a sol-gel method by providing magnesium nitrate and chromium nitrate (or zinc nitrate and chromium nitrate; or zinc nitrate and aluminum nitrate; or nickel nitrate and aluminum nitrate), adding ethylene glycol and citric acid thereto, and dissolving the mixture in deionized water; and
a step S2 of synthesizing the copper-based composite metal oxide heat storage material using a high-temperature solid-state method by uniformly mixing copper oxide and the spinel-type carriers according to a mass fraction ratio.

In accordance with this aspect, raw materials used in the sol-gel method are dispersed into a solvent, so that the prepared raw materials can obtain molecular level uniformity in a short time. In addition, the raw materials can be uniformly mixed in the molecular level when forming a gel. Therefore, the spinel-type carriers obtained by the sol-gel method in step S1 has high purity, high crystallinity, small particle size and uniform particle size distribution.

In the high-temperature solid-state method, the well-mixed spinel-type carriers and copper oxide particles are compounded at a high temperature, and a composite substance is finally obtained through contact, reaction, nucleation and crystal growth reactions between solid interfaces under the high-temperature condition. This preparation method has low cost, high yield, simple equipment and preparation process, and high production efficiency.

In an exemplary aspect of the present disclosure, the step S2 further includes:
a sub-step S21 of milling and mixing the copper oxide and the spinel-type carriers using a ball mill; and
a sub-step S22 of performing a high-temperature calcination on the mixed copper oxide powder and spinel-type carrier powder and cooling the mixed powder to obtain the copper-based composite metal oxide heat storage material.

In accordance with this aspect, the spinel-type carrier powder can uniformly and firmly adhere to the surfaces of the copper oxide powder during the high-temperature calcination of the uniformly mixed powdered copper oxide and spinel-type carriers in step S22, thereby effectively preventing the agglomeration and sintering phenomenon of the copper oxide powder under the high-temperature reaction condition, and obtaining the copper-based composite metal oxide heat storage material with excellent cyclic heat storage/heat release performance.

### DESCRIPTIONS OF THE DRAWINGS

FIG. 1 is a SEM (Scanning Electron Microscope) image of a copper oxide at different numbers of cycles;

FIG. 2 is a SEM image of a copper-based composite metal oxide heat storage material according to a first embodiment of the present disclosure at different numbers of cycles;

FIG. 3 shows specific surface areas of different heat storage materials after different numbers of cycles;

FIG. 4 is a plot of an x-ray diffraction analysis (XRD) for the copper-based composite metal oxide heat storage material according to the first embodiment of the present disclosure;

FIG. 5 is a flowchart of a preparation method according to a second embodiment of the present disclosure;

FIG. 6 is a flowchart of a step S2 of the preparation method according to the second embodiment of the present disclosure;

FIG. 7 is a schematic diagram of thermogravimetric curves for first reactions of four different copper-based composite metal oxide heat storage materials according to the present disclosure;

FIG. 8 is a schematic diagram of TG-DSC curves for energy densities of heat storage/heat release of four different copper-based composite metal oxide heat storage materials according to the present disclosure; and

FIG. 9 is a schematic diagram of thermogravimetric curves of four different copper-based composite metal oxide heat storage materials according to the present disclosure after multiple reaction cycles.

### DETAILED DESCRIPTION

The technical solution in the present disclosure will be clearly and completely described below with reference to the accompanying drawings in the present disclosure, and obviously, the described embodiment is merely a part of embodiments of the present disclosure, and are not all embodiments. Based on the embodiment of the present disclosure, all other embodiments obtained by those skilled in the art without creative efforts shall fall within the scope of the present disclosure.

### FIRST EMBODIMENT

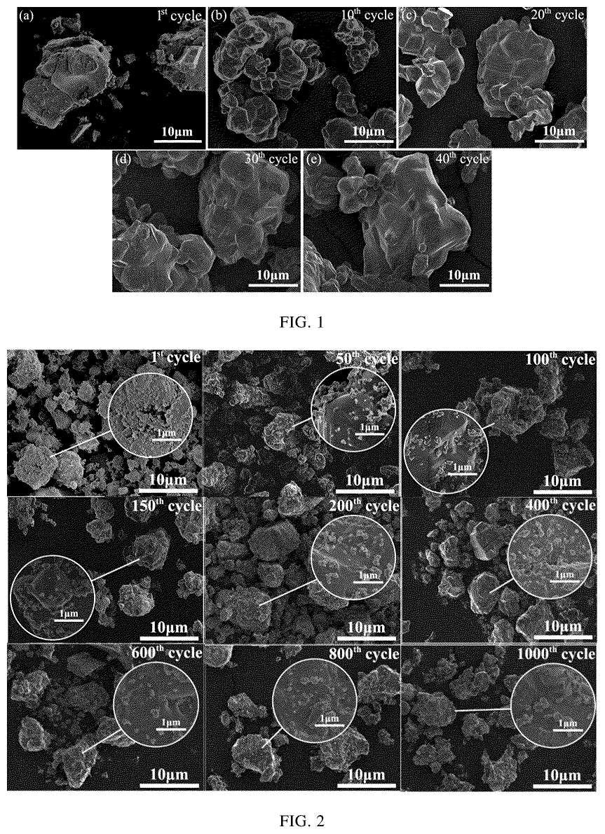

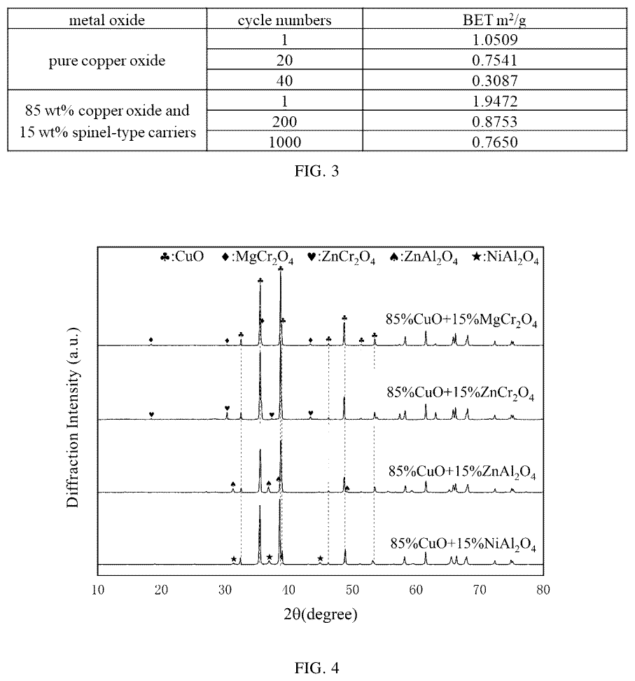

FIG. 1 is a SEM (Scanning Electron Microscope) image of a copper oxide at different numbers of cycles. As can be seen in FIG. 1, in the cycles of heat storage/heat release reactions, copper oxide particles undergo agglomeration growth as the number of cycles increases, and finally serious agglomeration and sintering phenomenon occurs, the copper oxide particles are fused together, and the densification becomes more severe with the increase of reaction times. FIG. 3 shows specific surface areas of different heat storage materials after different numbers of cycles. Referring to FIG. 3, a specific surface area BET of a pure copper oxide after one cycle is 1.0509 m²/g, while the specific surface area decreases to 0.7541 m²/g after 20 cycles, and only 0.3087 m²/g after 40 cycles, decreased by 3.4 times. As the number of cycles increases, the specific surface area rapidly decreases, indicating severe agglomeration and sintering phenomenon between the copper oxide particles. The decrease in specific surface area means that a large amount of the copper oxide materials cannot come into contact with the air, thus preventing re-oxidation reactions, and therefore, the cyclic heat storage/heat release performance of a pure copper oxide heat storage material is poor.

FIG. 2 is a SEM image of a copper-based composite metal oxide heat storage material according to the present disclosure at different numbers of cycles. Referring to FIGS. 2 and 3, in the embodiment, taking the copper-based composite metal oxide heat storage material with MgCr₂O₄ as spinel-type carriers as an example, the copper-based composite metal oxide heat storage material provided in the embodiment is obtained by forming a composite of the copper oxide particles and the spinel-type carriers, in which the spinel-type carriers (MgCr₂O₄) adhere to the surfaces of the copper oxide particles.

As can be seen in FIG. 2, as the 1 to 200 cycles of heat storage/heat release reactions proceed, due to the difference in surface energy driven by different grain sizes (Ostwald ripening theory), the aggregation and merging of small and large grains leads to a rapid increase in grain size, but after 200 cycles, the particle size of the heat storage material obtained by forming a composite of the spinel-type carriers and the copper oxide tends to remain unchanged, indicating that the spinel-type carriers on the surfaces of the copper oxide particles effectively suppresses the aggregation between the copper oxide particles. In addition, the particle size of the heat storage material obtained by forming a composite of the spinel-type carriers and the copper oxide after 200 to 1000 cycles is similar to that of the pure copper oxide heat storage material after only 20 cycles, indicating that the copper-based composite metal oxide heat storage material in the embodiment has better cyclic heat storage/heat release performance, and even after 1000 cycles, the spinel-type carriers still adhere to the surfaces of the copper oxide particles, further proving that even under high-temperature conditions and multiple cycles of heat storage/heat release reactions, a strong interaction force still exists between the spinel-type carriers and the copper oxide particles, the spinel-type carriers are not easy to fall off and the problem of agglomeration and sintering of the copper oxide at high temperatures is effectively solved.

As can be seen in FIG. 3, the specific surface area after 1st cycle of the copper-based composite metal oxide heat storage material provided by the embodiment is 1.9472 m²/g, which contributes to a part of specific surface area due to the spinel-type carriers adhering to the surfaces of the copper oxide. Due to grain growth, the specific surface area of the copper-based composite metal oxide heat storage material with the spinel-type carriers is reduced to 0.8753 m²/g after 200 cycles. Notably, the specific surface area of the copper-based composite metal oxide heat storage material is still 0.7650 m²/g after 1000 cycles, and is similar to that of the pure copper oxide after 20 cycles. This further confirms that the copper-based composite metal oxide heat storage material in the embodiment has superior cyclic heat storage/heat release performance. In addition, the copper-based composite metal oxide heat storage material with the spinel-type carriers still maintains a large specific surface area after 1000 cycles, and the larger the specific surface area of the material, the larger the chemical reaction area in contact with the air, and the more complete the reaction. Therefore, the copper-based composite metal oxide heat storage material provided by the embodiment has excellent reaction activity

FIG. 4 is a plot of an x-ray diffraction analysis for the copper-based composite metal oxide heat storage material according to the embodiment. Preferably, the spinel-type carriers are a combination of one or more of MgCr₂O₄, ZnCr₂O₄, ZnAl₂O₄, and NiAl₂O₄. Referring to FIG. 4, the composite metal oxides formed by different spinel-type carriers MgCr₂O₄, ZnCr₂O₄, ZnAl₂O₄ or NiAl₂O₄ and the copper oxide particles do not produce new phases, indicating that the spinel-type carriers can always exist alone under the high-temperature reaction conditions for heat storage/heat release reactions, without reacting with the copper oxide particles to form new substances, thereby avoiding reducing the content of the main reactant (copper oxide) in the copper-based composite metal oxide heat storage material and damaging the reaction activity of the copper oxide metal oxides, and ensuring that the copper-based composite metal oxide heat storage material has a high heat storage/heat release density.

Preferably, the mass fraction of the spinel-type carriers is equal to or more than 10% of the mass of the copper-based composite metal oxide heat storage material. Further preferably, the mass fraction of the copper oxide is 1-x, the mass fraction of the spinel-type carriers is x, and x is selected from a range of 10% to 20%.

In the embodiment, when the mass fraction of the spinel-type carriers is higher than 10%, it can effectively block the agglomeration between the copper oxide particles and avoid agglomeration and sintering phenomenon of the copper oxide particles under the high-temperature reaction condition. However, the higher the mass fraction of the spinel-type carriers, the lower the mass fraction of the copper oxide particles. The main reactant of the copper-based composite metal oxide heat storage material is the copper oxide particles, and the content of the copper oxide particles is low. Therefore, the energy density of the heat storage/heat release reaction of the material under the same mass conditions is reduced. Moreover, too many spinel-type carriers adhere to the surfaces of the copper oxide particles, easily causing insufficient contact reaction area between the copper oxide particles and air. Therefore, when the mass fraction of the spinel-type carriers is 10% to 20%, it is possible to give consideration to the heat storage/heat release performance and cycle performance of the copper-based composite metal oxide heat storage material. For example, with reference to FIGS. 2 to 4, the composite heat storage material of 85% copper oxide and 15% spinel-type carriers (MgCr₂O₄) can avoid sintering of the pure copper oxide under the high-temperature reaction condition, thereby having excellent heat storage/heat release performance and cyclic reaction performance.

Preferably, the spinel-type carriers are granular. When the granular spinel-type carriers adhere to the surfaces of the copper oxide particles, the granular spinel-type carriers are in point contact with the surfaces of the copper oxide particles, so that the blocking effect on the copper oxide particles is ensured, and meanwhile, the copper oxide particles have a large reaction contact area with air Therefore, in multiple cycles of heat storage/heat release reactions, the copper-based composite metal oxide heat storage material provided by the present disclosure has a large reaction area and the re-oxidation degree and reaction rate of the copper-based composite metal oxide heat storage material in the cycles of heat storage/heat release reactions are further improved.

Preferably, the surfaces of the copper oxide particles are uniformly coated with the granular spinel-type carriers. The spinel-type carriers having smaller particle size uniformly adhere to the surfaces of the copper oxide particles having larger particle size, so that the spinel-type carrier particles uniformly distributed on the surfaces of the copper oxide particles can block the agglomeration between the copper oxide particles without affecting the reaction area of the copper oxide particles and air, and the blocking effect of the spinel-type carrier with the same mass fraction on the agglomeration phenomenon between the copper oxide particles is improved to the maximum extent.

In the embodiment, first, due to a stable crystal form, strong structure, high melting point, and stable chemical properties of spinel-type materials, the spinel-type carriers in the copper-based composite metal oxide heat storage material provided in the present disclosure do not react with the copper oxide particles under the high-temperature reaction condition, which avoids a decrease in the content of the main reactant (copper oxide).

Second, there is a strong interaction between the spinel-type carriers and the copper oxide particles, so that the spinel-type carriers adhere to the surfaces of the copper oxide particles, and are not easy to fall off during multiple cycles of heat storage/heat release reactions.

Finally, the spinel-type carrier particles of the 10% to 20% uniformly adhere to the surfaces of the copper oxide particles, so that the contact between the copper oxide particles can be effectively blocked without significantly affecting the reaction area between the copper oxide particles and the air, the agglomeration and sintering of the copper oxide particles in the high-temperature reaction condition is avoided, the reaction rate and the reaction degree of the copper-based composite metal oxide heat storage material in the heat storage/heat release reaction are improved, and the high heat storage/heat release density and the cyclic reaction performance of the copper-based composite metal oxide are both considered.

### SECOND EMBODIMENT

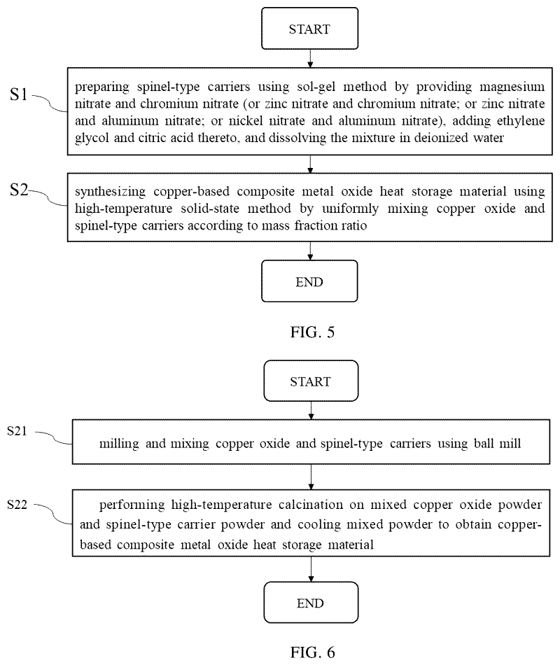

In the second embodiment of the present disclosure, a method for preparing the copper-based composite metal oxide heat storage material according to the first embodiment of the present disclosure is provided, FIG. 5 is a flowchart of a preparation method according to a second embodiment of the present disclosure. As shown in FIG. 5, the method includes:

a step S1 of preparing spinel-type carriers using a sol-gel method by providing magnesium nitrate and chromium nitrate (or zinc nitrate and chromium nitrate; or zinc nitrate and aluminum nitrate; or nickel nitrate and aluminum nitrate), adding ethylene glycol and citric acid thereto, and dissolving the mixture in deionized water; and a step S2 of synthesizing the copper-based composite metal oxide heat storage material using a high-temperature solid-state method by uniformly mixing copper oxide and the spinel-type carriers according to a mass fraction ratio.

Specifically, in step S1, the spinel-type carrier material is prepared by the sol-gel method. The sol-gel method is to uniformly mix raw materials in a liquid phase, carry out hydrolysis and condensation chemical reactions, and form a stable transparent sol system in the solution, age the sol, and slowly polymerize the sol particles to form a gel, dry and sinter the gel to prepare a nano-structured material. The sol-gel method can obtain molecular level uniformity in a relatively short time, so as to prepare a composite material with high purity and good crystal condition.

For example, in step S1, the main raw materials (magnesium nitrate and chromium nitrate; or zinc nitrate and chromium nitrate; or zinc nitrate and aluminum nitrate: or nickel nitrate and aluminum nitrate in a molar ratio of 1:2), citric acid, and ethylene glycol are first weighed separately, and then the added nitrate and citric acid are dissolved in an appropriate amount of the deionized water and stirred at a constant temperature of 70° C. for 3 hours under the action of a magnetic stirrer, and then the ethylene glycol is added, and the mixture is continuously stirred at a constant temperature of 90° C. for 2 hours using the magnetic stirrer. The raw materials are taken out after two times of stirring, and placed in a blast drying oven, the temperature of the drying oven is set to 200° C., and the drying time is 3 hours. After the drying is completed, the raw materials are placed in a tubular furnace with a heating rate of 10° C./min. first kept at 450° C. and calcined for 4 hours, then kept at 800° C. and calcined for 4 hours. Finally, after cooling to room temperature, the raw materials are taken out and ground into powder, and then the spinel-type carrier material is obtained.

Preferably, the main raw materials (magnesium nitrate and chromium nitrate: or zinc nitrate and chromium nitrate: or zinc nitrate and aluminum nitrate; or nickel nitrate and aluminum nitrate in a molar ratio of 1:2), citric acid, and ethylene glycol are weighed at a molar ratio of 3:3:2, this ratio ensures high purity of the prepared sample while reducing the amount of citric acid and ethylene glycol used.

Preferably, the purity grades of chemical agents such as magnesium nitrate and chromium nitrate (or zinc nitrate and chromium nitrate; or zinc nitrate and aluminum nitrate; or nickel nitrate and aluminum nitrate), citric acid, and ethylene glycol in the raw materials for preparing the spinel-type carrier material are analytical grade, with high purity and few interfering impurities. It is possible to minimize the influence of the impurities on the heat storage/heat release chemical reactions of the copper-based composite heat storage material, avoiding damage to the heat storage/heat release reaction characteristics and cycle performance of the heat storage material.

At step S2, the copper oxide and the spinel-type carriers are uniformly mixed according to the mass fraction ratio, and then the mixed powder is compounded using the high-temperature solid-state method. The synthesis by the high-temperature solid-state method is that a composite substance is finally obtained through contact, reaction, nucleation and crystal growth reactions between solid interfaces under the high-temperature condition. This preparation method has advantages of low cost, high yield, simple equipment and preparation process, and high production efficiency, and is suitable for large-scale industrial production.

Preferably, as shown in FIG. 6, the step S2 further includes:
a sub-step S21 of milling and mixing the copper oxide and the spinel-type carriers using a ball mill; and
a sub-step S22 of performing a high-temperature calcination on the mixed copper oxide powder and spinel-type carrier powder and cooling the mixed powder to obtain the copper-based composite metal oxide heat storage material.

For example, in step S21, the spinel-type carrier material prepared in step S1 and the copper oxide powder are weighed according to a corresponding mass fraction ratio, and ball-milled for 30 minutes by the ball mill, and then the fully mixed solid powder is placed in the tubular furnace with a heating rate of 10° C./min, kept at 900° C., and calcined for 4 hours. Finally, after cooling to room temperature, the calcined composite material is taken out to obtain the copper-based composite metal oxide heat storage material obtained by forming a composite of the spinel-type carriers and the copper oxide. The spinel-type carrier particles uniformly adhere to the surfaces of the copper oxide particles.

In the embodiment, the spinel-type carriers obtained by the sol-gel method in step S1 has high purity, high crystallinity, small particle size and uniform particle size. Moreover, after thoroughly mixed in step S21, the spinel-type carrier powder can uniformly adhere to the surfaces of the copper oxide powder during the high-temperature calcination of the uniformly mixed powdered copper oxide and spinel-type carriers in step S22, thereby effectively blocking the agglomeration and sintering of the copper oxide powder under the high-temperature reaction condition, and obtaining the copper-based composite metal oxide heat storage material with excellent cyclic heat storage/heat release performance.

The following experimental data further indicates excellent properties of the copper-based composite metal oxide heat storage material provided in the embodiment.

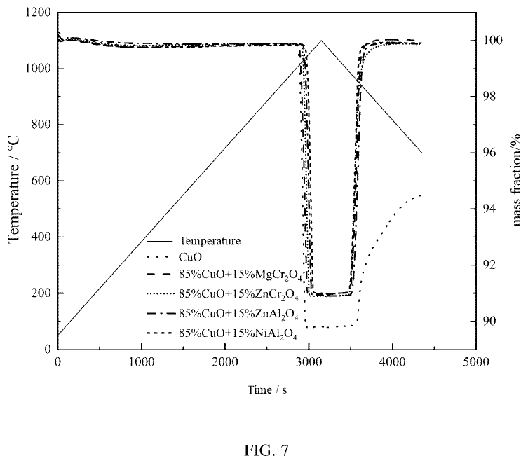

FIG. 7 is a schematic diagram of thermogravimetric curves for first reactions of four different copper-based composite metal oxide heat storage materials according to the present disclosure, in which the horizontal axis represents time in seconds, the vertical axis in the left column represents temperature in ° C., and the vertical axis in the right column represents the mass fraction of the reaction in %. The solid broken line represents a temperature change curve, a reduction reaction occurs when the copper-based metal oxide is subjected to a heat storage reaction, heat is absorbed, oxygen is released, and the mass is reduced; a reversible oxidation reaction occurs when the copper-based metal oxide is subjected to a heat release reaction, heat is released, oxygen is adsorbed, and the mass is increased. A thermo-gravimetric reaction curve of the pure copper oxide is shown by the dotted line in FIG. 7, and the reduction reaction can achieve a theoretical weight loss rate of about 10%. However, due to the problem of agglomeration and sintering of the copper oxide system under the high-temperature reaction condition, the oxidation performance during heat release reaction is poor, with a weight gain rate of only 4.6% during the oxidation process and a re-oxidation degree of 46%. The theoretical weight loss rate of the copper-based composite metal oxide heat storage material obtained by forming a composite of 85% of the mass fraction of the copper oxide and 15% of the mass fraction of the spinel-type carrier is about 8.5%. The four different spinel-type carriers (MgCr₂O₄, ZnCr₂O₄, ZnAl₂O₄, NiAl₂O₄) correspond to a scribe line, a short-dotted line, a dotted scribe line, and a short scribe line in FIG. 7, respectively, and each of these can achieve the theoretical weight loss rate, and oxidation performance is greatly improved and the re-oxidation degree is close to 100%, and each of these has a fast oxidation reaction rate and excellent reversibility of reduction reaction/oxidation reaction.

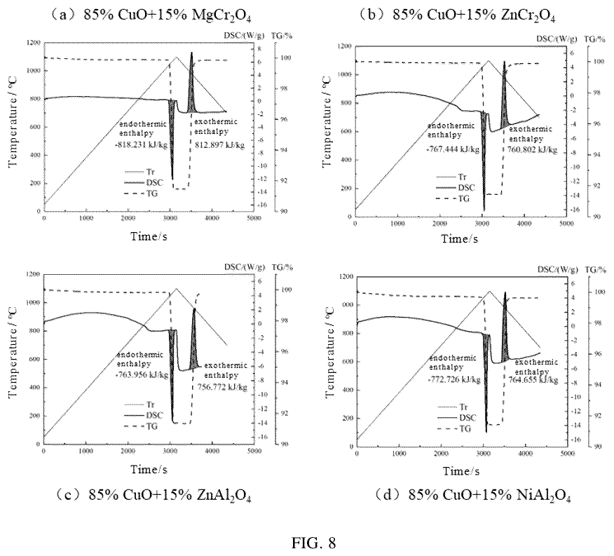

FIG. 8 is a schematic diagram of TG-DSC curves for energy densities of heat storage/heat release of four different copper-based composite metal oxide heat storage materials according to the present disclosure. Referring to FIG. 8, the horizontal axis represents time in seconds, the vertical axis in the left column represents temperature in ° C. and the vertical axis in the first right column represents heat flow data of DSC in W/g, and the vertical axis of the second right column represents mass fraction change data of TG in %. As shown, endothermic peaks and exothermic peaks represent the heat stored by the reduction reaction and the heat evolved from the oxidation reaction, respectively. (a) is a TG-DSC curve of a copper-based composite metal oxide heat storage material obtained by forming a composite of 85% of the mass fraction of the copper oxide and 15% of the mass fraction of MgCr₂O₄, showing a thermochemical heat storage density of −818.23 kJ/kg and a heat release density of 812.90 kJ/kg. (b) is a TG-DSC curve of a copper-based composite metal oxide heat storage material obtained by forming a composite of 85% of the mass fraction of the copper oxide and 15% of the mass fraction of ZnCr₂O₄, showing a thermochemical heat storage density of −767.444 kJ/kg and a heat release density of 764.813 kJ/kg. (c) is a TG-DSC curve of a metal oxide heat storage material obtained by forming a composite of 85% of the mass fraction of the copper oxide and 15% of the mass fraction of ZnAl₂O₄, showing a thermochemical heat storage density of −763.956 kJ/kg and a heat release density of 762.882 kJ/kg. (d) is a TG-DSC curve of a copper-based composite metal oxide heat storage material obtained by forming a composite of 85% of the mass fraction of the copper oxide and 15% of the mass fraction of NiAl₂O₄, showing a thermochemical heat storage density of −772.726 kJ/kg and a heat release density of 764.655 kJ/kg. This indicates that the CuO/Cu₂O composite substance coated with spinel-type structural carriers provided by the present disclosure has a high heat storage/heat release density and excellent reversibility of heat storage/heat release reaction.

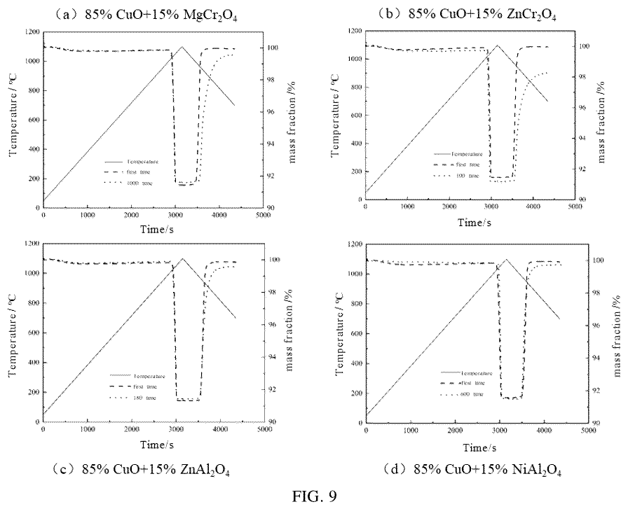

FIG. 9 is a schematic diagram of thermogravimetric curves of four different copper-based composite metal oxide heat storage materials according to the present disclosure after multiple reaction cycles. (a) is a TG curve of a copper-based composite metal oxide heat storage material obtained by forming a composite of 85% of the mass fraction of the copper oxide and 15% of the mass fraction of MgCr₂O₄ after multiple reaction cycles, showing that compared with the first cycle reaction, the reduction degree is 99% and the re-oxidation degree is as high as 98% after 1000 cycles. (b) is a TG curve of a copper-based composite metal oxide heat storage material obtained by forming a composite of 85% of the mass fraction of the copper oxide and 15% of the mass fraction of ZnCr₂O₄ after multiple reaction cycles, showing that the reduction degree is 99.82% and the re-oxidation degree is 83.36% after 100 cycles. (c) is a TG curve of a metal oxide heat storage material obtained by forming a composite of 85% of the mass fraction of the copper oxide and 15% of the mass fraction of ZnAl₂O₄ after multiple reaction cycles, showing that the reduction degree is 99.74% and the re-oxidation degree is 95.84% after 180 cycles. (b) is a TG curve of a copper-based composite metal oxide heat storage material obtained by forming a composite of 85% of the mass fraction of the copper oxide and 15% of the mass fraction of NiAl₂O₄ after multiple reaction cycles, showing that the reduction degree is 99.91% and the re-oxidation degree is still 98.77% after 600 cycles. According to FIG. 9, it can be shown that the copper-based composite metal oxide heat storage material obtained by forming a composite of the copper oxide and the spinel-type carriers provided by the present disclosure has a high re-oxidation degree in multiple cycles of heat storage/heat release, that is, the copper-based composite metal oxide heat storage material provided by the present disclosure has excellent cyclic reaction performance.

In the embodiments of the present disclosure, a copper-based composite metal oxide heat storage material, in which spinel-type carriers uniformly adhere to surfaces of copper oxide particles, and a preparation method thereof are provided. When compared with the prior art, the copper-based composite metal oxide heat storage material provided by the present disclosure overcomes the problems of low oxidation reaction degree, slow reaction rate, and poor cycle performance caused by the agglomeration and sintering of traditional copper-based metal oxides at high temperatures. Referring to FIGS. 7 to 9, the copper-based metal oxide can achieve a theoretical reduction rate and a high re-oxidation degree, with fast reaction rates in both reduction reaction process and oxidation reaction process. According to the preparation method provided by the present disclosure, the spinel-type carrier powder with uniform particle size can be uniformly coated on the surfaces of CuO/Cu₂O and interact more strongly with CuO/Cu₂O, the carriers can firmly and stably adhere during the cyclic reaction process, and the spinel-type carriers do not react with CuO/Cu₂O, avoiding the reduction of heat storage/heat release energy density and the loss of reaction performance. In addition, the spinel-type carrier adheres to the surfaces of the copper oxide particles in the form of particles, so as not to affect the oxygen desorption/adsorption ability and oxygen ion migration rate of the copper-based composite metal oxide heat storage material, and this not only effectively solves the agglomeration sintering problem, but also ensures excellent cyclic reaction characteristics.

The technical solutions of the present disclosure have been described with reference to the accompanying drawings. However, it is easily understood by those skilled in the art that the protection scope of the present disclosure is obviously not limited to the above specific embodiment. Those skilled in the art can make equivalent changes or substitutions to related technical features without departing from the principle of the present disclosure, and the technical solutions after these changes or substitutions shall fall within the protection scope of the present disclosure.

1. A copper-based composite metal oxide heat storage material formed of a composite of copper oxide particles and spinel-type carriers, in which the spinel-type carriers adhere to surfaces of the copper oxide particles.

2. The copper-based composite metal oxide heat storage material according to claim 1, wherein the mass fraction of the spinel-type carriers is equal to or more than 10% of the mass of the copper-based composite metal oxide heat storage material.

3. The copper-based composite metal oxide heat storage material according to claim 2, wherein the mass fraction of the copper oxide particles is 1-x, the mass fraction of the spinel-type carriers is x, and x is selected from a range of 10% to 20%.

4. The copper-based composite metal oxide heat storage material according to claim 1, wherein the spinel-type carriers are granular.

5. The copper-based composite metal oxide heat storage material according to claim 4, wherein the surfaces of the copper oxide particles are uniformly coated with the granular spinel-type carriers.

6. The copper-based composite metal oxide heat storage material according to claim 1, wherein the spinel-type carriers are a combination of one or more of MgCr₂O₄, ZnCr₂O₄, and ZnAl₂O₄, NiAl₂O₄.

7. A method for preparing the copper-based composite metal oxide heat storage material according to claim 1, the method comprising:
preparing the spinel-type carriers using a sol-gel method by providing magnesium nitrate and chromium nitrate, zinc nitrate and chromium nitrate, zinc nitrate and aluminum nitrate, or nickel nitrate and aluminum nitrate, adding ethylene glycol and citric acid thereto, and dissolving the mixture in deionized water; and
synthesizing the copper-based composite metal oxide heat storage material using a high-temperature solid-state method by uniformly mixing copper oxide and the spinel-type carriers according to a mass fraction ratio.

8. The preparation method of the copper-based composite metal oxide heat storage material according to claim 7, wherein the synthesizing further includes:
milling and mixing the copper oxide and the spinel-type carriers using a ball mill to form a mixed copper oxide powder and spinel-type carrier powder; and
performing a high-temperature calcination on the mixed copper oxide powder and spinel-type carrier powder and cooling the mixed copper oxide powder and spinel-type carrier powder to obtain the copper-based composite metal oxide heat storage material.
